(19) United States
(12) Patent Application Publication
(10) Pub. No.: US 2011/0058104 A1
(43) Pub. Date: Mar. 10, 2011

(54) VIDEO SIGNAL PROCESSING APPARATUS AND VIDEO SIGNAL PROCESSING METHOD

(76) Inventor: Yuta Arai, Takasaki-shi (JP)

(21) Appl. No.: 12/718,554

(22) Filed: Mar. 5, 2010

(30) Foreign Application Priority Data
Sep. 9, 2009 (JP) 2009-208684

(51) Int. Cl. H04N 5/14

(52) U.S. Cl. 348/571; 348/E05.062

(57) ABSTRACT

A video signal processing apparatus includes: a video converter configured to generate video data by sampling a video signal with a predetermined resolution inputted from the outside at an arbitrary sampling frequency and capable of processings of scaling and filtering in a horizontal and a vertical direction to the generated video data, and performing the processing by receiving control; and a controller configured to control, when the input of the predetermined video display mode is received by the receiver, the sampling frequency to make the number of display pixels in the horizontal direction of the video data be close to the number of pixels of a display panel.

### CROSS-REFERENCE TO THE INVENTION

This application is based upon and claims the benefit of priority from the prior Japanese Patent Application No. 2009-208684, filed on Sep. 9, 2009; the entire contents of which are incorporated herein by reference.

### BACKGROUND OF THE INVENTION

1. Field of the Invention

The present invention relates to a video signal processing apparatus and a video signal processing method for example.

2. Description of the Related Art

With the start of terrestrial digital broadcast, there are commercialized many television apparatuses (hereinafter, referred to as “HDTV”) having large-sized screen liquid crystal flat panels (hereinafter, referred to as “full HD panel”) capable of full specification high definition display.

The HDTV has an external video signal input terminal such as an HDMI terminal and a D terminal, and input of a game video of a video game player into the D terminal for example enables display of the game video in a large-sized screen so that the game can be enjoyed.

Meanwhile, a resolution of a game video inputted from a video game player to the D terminal is 480 P (720×480 progressive) or the like for example, and if such a video is simply displayed dot by dot, a video of a small angle of view is set in a full HD panel, and then a scaling processing of enlargement to a full screen size is generally performed.

However, enlarged display in a screen with an aspect ratio different from that of a video of an input origin deteriorates a circularity ratio, flattening the video and generating a sense of incompatibility in viewing.

As a technology for displaying while maintaining a circularity ratio in a case that an aspect ratio of a video of an input origin and an aspect ratio of a display panel are different as above, there is disclosed a video signal processing apparatus enabling display of a high-quality video even when a resolution of an input video and a resolution of a display apparatus are different by setting a sampling frequency of a digital video signal to have a sampling number which does not require digital data to be scaled in a horizontal direction in accordance with a horizontal resolution of the display apparatus for example (see JP-A 2006-227442 (KOKKAI) for example).

### BRIEF SUMMARY OF THE INVENTION

However, in a case of the above-described conventional technology, though the technology about aspect ratios of 4:3 to 16:9 and 16:9 to 4:3 are described, a technology for changing an aspect ratio of 3:2 of a game video or the like to 16:9 is not described, and there is a problem that enlarged display cannot be performed while a circularity ratio of the game video maintained.

The present invention is made to solve such a problem and its object is to provide a video signal processing apparatus and a video signal processing method in which a video inputted to an external video signal input terminal is enlargedly displayed with a circularity ratio being maintained and a high-quality video without image degradation can be displayed.

A video signal processing apparatus according to an aspect of the present invention includes: a receiver configured to receive input of a predetermined video display mode; a video converter configured to generate video data by sampling a video signal with a predetermined resolution inputted from the outside at an arbitrary sampling frequency and capable of processings of scaling and filtering in a horizontal and a vertical direction to the generated video data, and performing the processing by receiving control; and a controller configured to control, when the input of the predetermined video display mode is received by the receiver, the sampling frequency to make the number of display pixels in the horizontal direction of the video data be close to the number of pixels of a display panel and to control the video converter not to perform the scaling processing in the horizontal direction.

A video signal processing method according to an aspect of the present invention includes: controlling, when input of a predetermined video display mode is received, a sampling frequency to make the number of display pixels in a horizontal direction of then video data be close to the number of pixels of a display panel; generating digital video data by sampling an analog video signal with a predetermined resolution inputted from the outside at the controlled sampling frequency; and controlling not to perform a scaling processing in a horizontal direction to the generated video data.

According to the present invention, it is possible to enlargedly display a video inputted to an external video signal input terminal while maintaining a circularity ratio and to display a high-quality video without image degradation.

### BRIEF DESCRIPTION OF THE DRAWINGS

FIG. 1 is a diagram showing a constitution of a video signal processing apparatus of an embodiment of the present invention.

FIG. 2 is a diagram showing an example of a video menu.

FIG. 3 is a diagram showing an example of a game screen menu.

FIG. 4 is a diagram showing an example of sampling frequencies in a horizontal valid period.

FIG. 5 is a diagram showing an example in which a game video is displayed in a full HD panel with 1708×960 pixels.

FIG. 6 is a diagram showing an example in which a game video is displayed in a full HD panel with 1920×1080 pixels.

### DETAILED DESCRIPTION OF THE EMBODIMENT

Hereinafter, a television apparatus of an embodiment according to a video signal processing apparatus of the present invention will be described in detail with reference to the drawings.

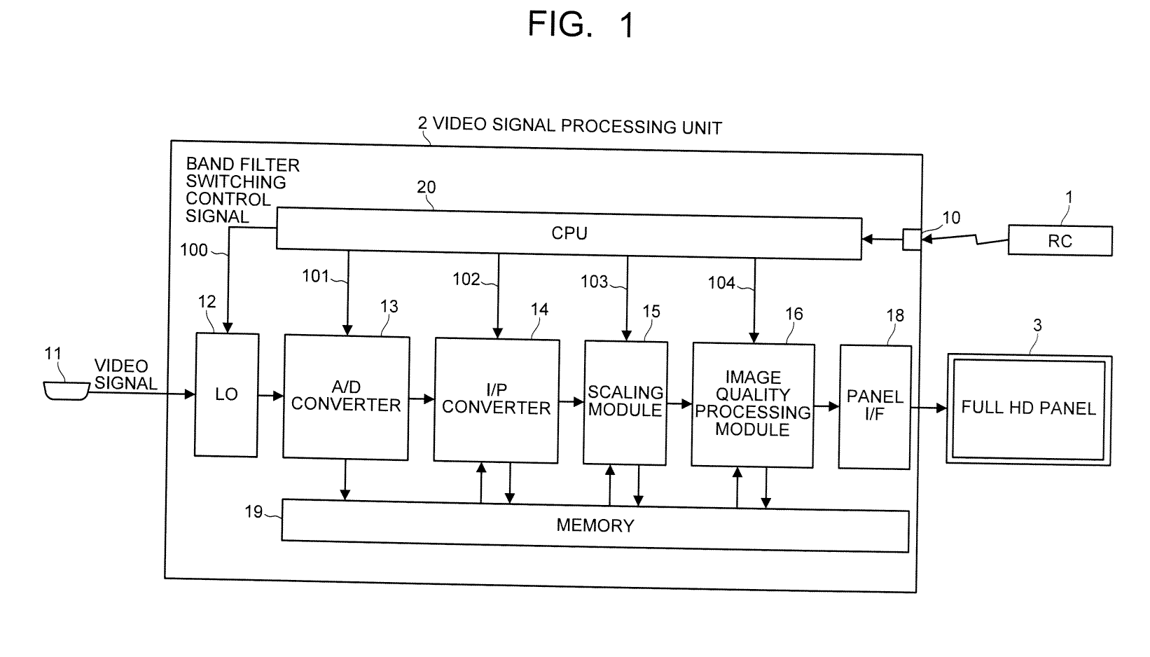

FIG. 1 is a diagram showing a constitution of the television apparatus.

As shown in FIG. 1, the television apparatus of this embodiment has a remote controller 1 (hereinafter, referred to as “RC 1”) as a manipulation unit a video signal processing unit 2, and a large-sized screen liquid crystal flat panel 3 (hereinafter, referred to as “full HD panel 3”) capable of full specification high vision display.

The manipulation unit can be a button provided in a TV main body other than the RC 1.

The full HD panel 3 has a screen of a full HD size (1920×1080 pixels) (aspect ratio 16:9).

This screen has a resolution of at least twice the number of vertical-direction lines of a game video of 720×480 pixels (aspect ratio 3:2).

This screen can draw a video with arbitrarily designated numbers of horizontal and vertical display pixels.

The video outputted from the video signal processing unit 2 is displayed in this screen.

The RC 1 is connected to the video signal processing unit 2 by radio communication such as infrared communication.

Multiple buttons for manipulating functions housed in the television apparatus are provided in the RC 1.

A command is issued from an infrared transmitter (not shown) of the RC 1 by manipulation of the desired button.

A CPU 20 accepts this command via an infrared receiver 10 of the video signal processing unit 2 and performs a processing corresponding to the command.

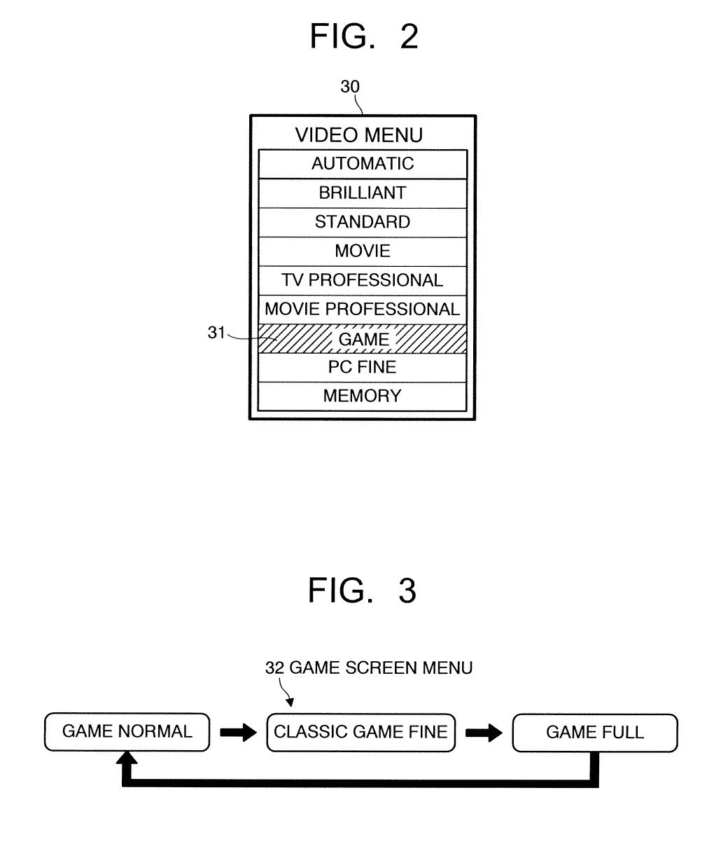

By button manipulation of a video menu of the RC 1 for example, as shown in FIG. 2, the CPU 20 displays a video menu 30 in which setting items are longitudinally laid out in the screen of the full HD panel 3.

As the setting items of the video menu 30, there are, for example, “automatic”, “brilliant”, “standard”, “movie”, “TV professional”, “movie professional”, “game”, “PC fine”, “memory” and so on.

When a viewer designates the setting item such as “game” 31 in the video menu with the RC 1, the CPU 20 stores “game mode” as an operation mode in a memory 19, and performs screen control in “game mode”.

Viewer's manipulation of the button of a game screen menu of the RC 1 during this “game mode” makes the CPU 20 display a game screen menu 32 shown in FIG. 3.

Three screen setting items such as “game normal”, “classic game fine”, “game full” are cyclically displayed in the game screen menu 32.

Every time a user manipulates the button for designating the item in the RC 1, the item of the screen setting changes to the next item, so that a desired screen can be set.

In other words, the game screen menu 32 is a screen setting menu dedicated to games, for designating an angle of view (size of the game screen) of the game video in the game mode.

The game screen menu 32 shown here is only an example and other examples can be thought of.

The item “game normal” is a setting to display an inputted video almost without modification.

The item “classic game fine” is a setting to display a game screen in which priority is given to an image quality and is suitable for playing a classic game which has been enjoyed in past years with a brilliant video with texture of dots.

The item “game full” is a setting to display a game screen in which priority is given to a size of the screen, displaying the game screen to fill a screen of 16:9 for example.

In this menu, though items of three screen settings are cyclically repeated, the setting items can be longitudinally laid out so that the setting item can be selected by button manipulation in a longitudinal direction, similarly to in the video menu 30 shown in FIG. 2 above.

The video signal processing unit 2 has the infrared receiver 10, the D terminal 11, a low pass filter (LO) 12, an analog/digital converter 13 (hereinafter, referred to as “A/D converter 13”), an I/P converter 14, a scaling module 15, an image quality processing module 16, a panel I/F 18, a memory 19, the CPU 20 and so on.

The infrared receiver 10 receives the command of button manipulation issued from the RC 1 and transmits to the CPU 20.

The D terminal 11 is a video signal input terminal into which analog component terminals are united and through which a type (number of scan lines, frame plate, I/P information (information of interlace signal/progressive signal), aspect ratio, and the like) of the video can be transmitted from a control line, as format information of the video.

A D terminal cable from the portable video game player for example is connected to the D terminal 11 and an analog video signal of a resolution of 480 P (720×480 progressive) is inputted thereto. Hereinafter, this video signal is referred to as a game video.

The low pass filter (LO) 12 is a band filter filtering off an unnecessary band at a time of sampling data from the analog video signal (game video) inputted from the D terminal 11.

In other words, the low pass filter (LO) 12 passes a frequency band necessary for sampling a video according to Nyquist theorem.

The A/D converter 13 samples the video signal of the band having been passed by the low pass filter (LO) 12 with a sampling frequency (64 MHz in “classic game fine” and 72 MHz in “game full”) designated by the CPU 20, converts the video signal into digital video data, and stores in the memory 19.

In other words, the A/D converter 13 samples an analog video signal of a predetermined resolution inputted from the outside with a designated sampling frequency, thereby generating digital video data.

The I/P converter 14, by a control signal 102 from the CPU 20, reads the digital video data stored in the memory 19, and converts an I (interlace) signal into a P (progressive) signal and stores in memory 19.

In a case of a game video, since an original video signal is a progressive signal, I/P conversion is not performed.

The scaling module 15, by a control signal 103 from the CPU 20, reads the progressive video signal stored in the memory 19 via the I/P converter 14 from the memory 19 and performs a scaling processing, that is, controls an enlargement ratio of enlargement or reduction.

In this example, since the screen of the full HD panel 3 is large in relation to the original video, the video is enlarged.

Further, the scaling module 15 has scaling filters performing a correction (edge correction) of an edge of a video each in a horizontal direction and a vertical direction.

The scaling filter in the horizontal direction is called a horizontal scaling filter, while the scaling filter in the vertical direction is called a vertical scaling filter.

The scaling module 15 performs an edge correction to an edge of an enlarged or reduced video in each of the horizontal and vertical directions by an edge correction function of the scaling filter.

The edge correction is a processing to smoothen an edge of a video while blurring the edge.

The scaling module 15 is capable of processings of scaling and filtering of the video data generated by the A/D converter 13 in the horizontal direction and in the vertical direction.

The scaling filter 15 functions as a video converter performing the processing by receiving control from the CPU 20.

For example, as a result that “classic game fine” is designated, the scaling module 15 refrains from performing the processings of scaling (enlargement ratio control) and filtering (the edge correction function of the scaling filter is turned off) of the video data generated by the A/D converter 13 with regard to at least in one of the directions of display pixels in the horizontal direction and display pixels in the vertical direction.

The image quality processing module 16 adjusts an image quality of the video by designation by a control signal 104, that is, performs a gamma correction, an image quality correction and the like of the video.

The panel I/F 18 is an interface for drawing (outputting) the video via the image quality processing module 16 in the screen of the full HD panel 3, and converts the video into a signal format compliant with a panel standard.

For example, when “classic fine” is designated in “game mode”, neither scaling (enlargement ratio control) in the horizontal direction nor the edge correction by the horizontal scaling filter is performed, and with regard to the vertical direction, scaling to two times (2×) (integral multiple) is performed but the edge correction by the vertical scaling filter is not performed.

It should be noted that image quality adjustment (gamma correction, image quality correction or the like) is performed as in a regular setting.

When “game full” is designated in “game mode”, neither scaling (enlargement ratio control) in the horizontal direction nor the edge correction by the horizontal scaling filter is performed, and only in the vertical direction scaling at a rate of 2.25-times (2.25×) and the edge correction by the vertical scaling filter are performed.

It should be noted that image quality adjustment (gamma correction, image quality correction or the like) is performed as in the regular setting.

The memory 19 is a dynamic RAM or the like and is a temporary storage place of the video data being processed.

Further, the memory 19 functions as a working area in which the CPU 20 processes data.

The CPU 20 functions as a receiver receiving input of a predetermined video display mode (in a case that “classic game fine” is selected and inputted in the setting of “game mode” or in a case that “game full” is selected and inputted in the setting of “game mode”).

Further, the CPU 20 outputs the control signals 101 to 104 to the above-described respective sections and performs control for drawing the video in the screen of the full HD panel 3.

When the CPU 20 receives input of the predetermined video display mode, the CPU 20 controls the sampling frequency so that the number of display pixels of the video data in the horizontal direction becomes close to the number of pixels of the full HD panel 3 and controls the scaling module 15 not to perform the scaling processing in the horizontal direction.

More specifically, when the operation mode is “game mode” and “classic game fine” is designated in the game screen menu for example, the CPU 20 controls the respective sections as below.

To the A/D converter, the CPU 20 outputs the control signal 101 to raise a frequency of a sampling clock in a horizontal valid period at 64 MHz and, with regard to the vertical direction, to import 480 lines without change.

To the scaling module 15, the CPU 20 outputs the control signal 103 not to perform scaling in the horizontal direction and, with regard to the vertical direction, to perform scaling at a rate of two times (2×) and not to perform an edge correction by the vertical scaling filter.

To the image quality processing module 16, the CPU 20 outputs the control signal 104 to perform image quality adjustment (gamma correction, image quality correction and the like) in accordance with an existing setting.

In other words, when “game mode” and “classic game fine” are designated, in this mode the CPU 20 controls the sampling frequency for the horizontal valid period of the A/D converter 13 to be 64 MHz and controls the game video to be imported with the number in the vertical direction unchanged.

On the other hand, the CPU 20 controls the scaling module 15 not to perform scaling in the horizontal direction and, with regard to the vertical direction, to perform scaling at a rate of an integral multiple.

If the operation mode is “game mode” and “game full” is designated in the game screen menu for example, the CPU 20 controls the respective sections as below.

To the A/D converter, the CPU 20 outputs the control signal 101 to raise the frequency of the sampling clock in the horizontal valid period to 72 MHz and, with regard to the vertical direction, to import 480 lines without change.

To the scaling module 15, the CPU 20 outputs the control signal 103 not to perform scaling in the horizontal direction and, with regard to the vertical direction, to perform scaling at a rate of 2.25-times (2.25×) and to perform the edge correction by the vertical scaling filter.

In other words, when “game mode” and “game full” are designated, in this mode the CPU 20 controls the sampling frequency for the horizontal valid period of the A/D converter 13 to be 72 MHz and, with regard to the vertical direction, controls the game video to be imported with the number thereof unchanged.

Meanwhile, the CPU 20 controls the scaling module 15 not to perform scaling in the horizontal direction and, with regard to the vertical direction, to perform scaling at the rate of 2.25-times (2.25×) and to perform filtering (apply vertical scaling filter).

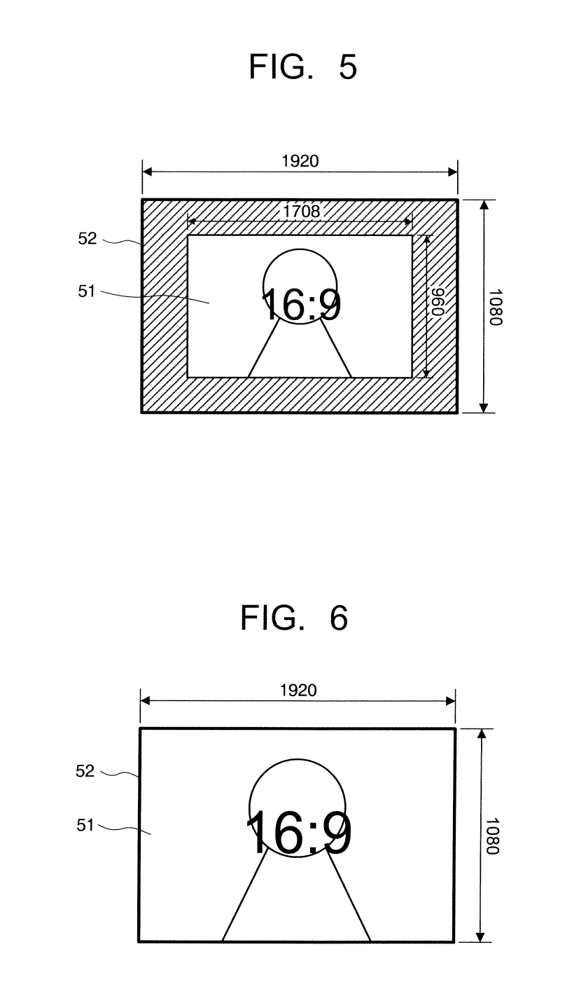

Subsequently, an operation of this television apparatus will be described with reference to FIG. 5 and FIG. 6.

In this television apparatus, when a game video (for example 480 P) is inputted to the D terminal 11, A/D conversion is performed after band filtering.

Thereafter, the video to which scaling, filtering and image quality adjustment are performed is displayed in the full HD panel 3.

Conventionally, when a control signal 101 is inputted from a CPU 20 to an A/D converter 13, the A/D converter 13 sets a sampling clock at 27 MHz and samples data from an input video, so that a game video is imported in a memory 19 at an angle of view of 720×480 pixels (aspect ratio 3:2).

When a screen size of a display panel is of full HD size (1920×1080 pixels) (aspect ratio 16:9), in dot-by-dot display by 720×480 pixels (aspect ratio 3:2), a display size of a game video in relation to a screen size of a display panel is quite small, and in addition, the aspect ratio of 3:2 of the game video is different from the aspect ratio of 16:9 of the display panel, and consequently a circularity ratio of the game video is deteriorated.

Thus, usually, in order that image conversion is always performed both horizontally and vertically to video data imported into the memory 19, the CPU 20 outputs a control signal 103 to a scaling module 15, thereby performing scaling and filtering uniformly to the video data and outputting the video data to a full HD panel 3.

Thus, the game video inputted to the full HD panel 3 is enlargedly displayed, but image blurring occurs.

On the other hand, when the operation mode of the screen control is set to “game mode” in the video menu (see FIG. 2) and “classic game fine” is set (designated) in the game screen menu (see FIG. 3), the CPU 20 outputs the control signal 101 to the A/D converter 13 to raise the frequency of the sampling clock in the horizontal direction to 64 MHz and, with regard to the vertical direction, to import 480 lines without changing the number.

Further, the CPU 20 outputs the control signal 103 to the scaling module 15 not to perform scaling in the horizontal direction and, with regard to the vertical direction, to perform scaling at a rate of two times (2×).

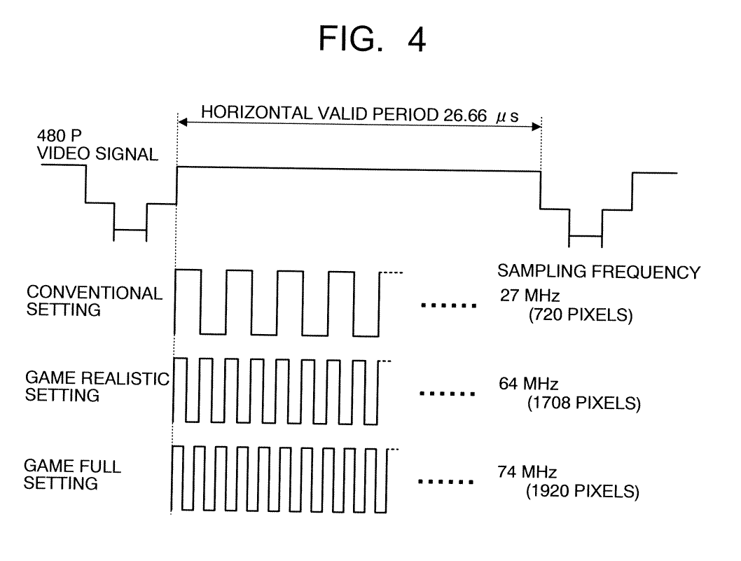

As a result of this control, as shown in FIG. 4 the A/D converter 13 sets the frequency of the sampling clock in the horizontal valid period to 64 MHz and performs sampling of 1708 times in a horizontal valid period of 26.66 μs.

Thereby, horizontal valid pixels are sampled with the number thereof being 1708 pixels and a screen in which the sampled horizontal valid pixels of 1708 pixels are pasted without change is outputted.

With regard to the vertical direction, data of 480 lines is imported by the A/D converter 13 and is scaled (enlarged) at a rate of two times (2×) (960 lines) in the scaling module 15.

As a result, as shown in FIG. 5, a game video 51 is displayed in a screen 52 of the full HD panel 3 with 1708×960 pixels (aspect ratio of 16:9).

On this occasion, since an enlargement ratio in the vertical direction is an integral multiple (two times; 2×), even without scaling and filtering in the horizontal direction by the scaling module 15, the game video can be displayed in the full HD panel 3 with a circularity ratio maintained and without a sense of incompatibility by writing the same color information into a horizontal line, that is, by double distribution.

Next, another operation example will be described with reference to FIG. 6.

When the operation mode of the screen control is set to “game mode” in the video menu (see FIG. 2) and “game full” is set (designated) in the game screen menu (see FIG. 3), the CPU 20 outputs a control signal 101 to the A/D converter 13 to raise the frequency of the sampling clock to 72 MHz.

Further, the CPU 20 outputs a control signal 103 to the scaling module 15 not to perform scaling in the horizontal direction and, with regard to the vertical direction, to perform scaling at a rate of 2.25-times (2.25×).

By input of the control signal 101, the A/D converter 13 raises the frequency of the sampling clock to 72 MHz and performs sampling with the number of horizontal valid pixel being 1920 pixels.

Further, the scaling module 15 pastes the 1920 pixels in a game screen without performing a scaling processing in the horizontal direction.

With regard to the vertical direction, the A/D converter 13 imports video data of 480 lines and the scaling module 15 performs a scaling processing so that lines in the vertical direction is enlarged 2.25-times (2.25×), to be 1080 lines.

It should be noted that since scaling (enlargement ratio) in the vertical direction is not at an integral multiple, the scaling module 15 performs an edge correction to the enlarged video by the vertical scaling filter. The horizontal scaling filter is turned off.

As a result, as shown in FIG. 6, a game video 51 of full HD (1920×1080 pixels) enlarged to fill a screen 52 of a full HD panel 3 is displayed in the full HD panel 3.

In this case a circularity ratio is also maintained.

Since the enlargement ratio (2.25-times (2.25×)=1080/480) in the vertical direction is not an integral value, it is necessary to turn on the vertical scaling filter and to perform the edge correction. Meanwhile, with regard to the horizontal direction, full HD display is possible without performing the processings of scaling and filtering, so that specification of a full HD television is fulfilled and a commercial value as a television can be heightened.

AS stated above, according the television apparatus of this embodiment, when the operation mode of the screen control is set to “game mode” and “classic game fine” is designated in the game screen menu, by raising the sampling frequency of the A/D converter 13 in the horizontal valid period to 64 MHz, the game video can be enlargedly displayed in the full HD panel 3 without deterioration of the aspect ratio of the original video inputted from the game player to the D terminal 11. Further, since neither scaling nor filtering in the horizontal direction is performed, an image quality is not degraded, so that a realistic game video created by a game creator can be displayed.

In other words, it is possible to display a game video while maintaining an aspect ratio (lateral/longitudinal ratio) of 16:9 and a circularity ratio of a video without performing horizontal scaling and filtering.

Further, performing enlarged display while turning off the edge correction function of the scaling filter of the scaling module 15 enables brilliant display of contour portions of the video.

In other words, by performing enlarged display while maintaining a circularity ratio of a video of a portable video game player inputted to a D terminal 11 and displaying a high quality game video without image quality degradation in a full HD panel 3, a viewer can enjoy a realistic game video.

Recently, a classic game enjoyed in past years can be downloaded to a game player by connecting the game player to a network such as the Internet, and setting to the menu item “classic game fine” enables such a classic game to be played with a brilliant video with texture of dots.

It should be noted that the present invention is not limited to the above-described embodiment but a component can be modified in a practical phase without departing from the range of the gist of the present invention.

In the above-described embodiment, three modes of “game normal”, “classic game fine”, and “game full” are provided, but it suffices that only either one of “classic game fine” and “game full” is provided.

In the above-described embodiment, though a case of the inputted game video of 480 P is described, there is a case of other than 480 P, for example, of 720 P, and such a case will be described.

The CPU 20 obtains format information of a video inputted from the control line of the D terminal 11, and judges whether an inputted game video is of 480 P or 720 P based on a type of the video (number of scan lines, frame rate, I/P information, aspect ratio, and the like). Then, when the game video is of 480 P, the CPU 20 performs the processings of above-described contents.

On the other hand, in a case that the inputted game video is judged to be of 720 P from the format information of the video, when a viewer selects “game” from the video menu 30 shown in FIG. 2 and sets the operation mode to “game mode”, even if the viewer makes the game screen menu 32 of FIG. 3 displayed and attempts to designate “classic game fine”, the CPU 20 changes the item name to “dot by dot”.

In other words, if the type of the video is of 480 P as a result of judgment, the CPU 20 displays an item for performing video conversion in the game screen menu 32 when the operation mode is “game mode”.

On the other hand, if the type of the video is not of 480 p, that is, is of 720 P, the CPU 20 displays the item for performing dot-by-dot display in the game screen menu 32 even if the operation mode is “game mode”.

Thereby, in the case of 720 P, the game video inputted to the video signal processing unit 2 is outputted to the full HD panel 3 without being enlarged/reduced, and then displayed in the screen.

In a case that the game video of other than 480 P is inputted and displayed in the screen without being enlarged, if the game video is of 720 P, a circularity ratio of 100% is also secured with an aspect ratio of 16:9, and degradation of the video due to scaling does not occur, bringing in a video with more pixels than in a case of 480 P, which is easy to view.

In other words, by displaying the mode of classic game fine in the case of 480 P and displaying the menu of dot by dot instead of displaying the menu of classic game fine in the case of 720 P, it is possible to provide an optimal screen size/screen quality for a user.

It is possible to realize each component described in the above-described embodiment by a program installed in a storage such as a hard disk device of a computer.

Further, it is also possible to make a computer realize a function of the present invention by storing the above-described program in a computer-readable electronic medium and making the computer read the program from the electronic medium.

As an electronic medium, for example, storage medium such as a CD-ROM, flash memory, removable medium and the like are included.

Further, it is also possible to realize the function of the present invention by storing the components dispersedly in different computers connected via a network and communicating among computers in which the respective components are functioned.

### Other Embodiments

It should be noted that the present invention is not limited to the above-described embodiment but a component can be modified in a practical phase without departing from the range of the gist of the present invention.

By properly combining a plurality of components disclosed in the above-described embodiment, various inventions can be constituted. For example, some components can be deleted from the entire components shown in the embodiment.

In other words, the embodiment of the present invention is not limited to the above-described embodiment and can be expanded and modified, and the expanded or modified embodiment is included in the technical range of the present invention.

What is claimed is:

1. A video signal processing apparatus, comprising:
a receiver configured to receive input of a predetermined video display mode;
a video converter configured to generate video data by sampling a video signal with a predetermined resolution inputted from the outside at an arbitrary sampling frequency and capable of processings of scaling and filtering in a horizontal and a vertical direction to the generated video data, and performing the processing by receiving control; and
a controller configured to control, when the input of the predetermined video display mode is received by the receiver, the sampling frequency to make the number of display pixels in the horizontal direction of the video data be close to the number of pixels of a display panel and to control the video converter not to perform the scaling processing in the horizontal direction.

2. The video signal processing apparatus of claim 1,
wherein when the predetermined video display mode is a mode to display a game video of 480 P, in this mode the controller controls a sampling frequency in a horizontal valid period of the video converter to be 64 MHz and controls a game video to be imported with the number of the lines unchanged with regard to the vertical direction, and controls the video converter not to perform scaling in the horizontal direction and to perform scaling in the vertical direction at a rate of an integral multiple.

3. The video signal processing apparatus of claim 1,
wherein when the predetermined video display mode is a mode to display a game video of 480 P, in this mode the controller controls a sampling frequency in a horizontal valid period of the video converter to be 72 MHz and controls a game video to be imported with the number of the lines unchanged with regard to the vertical direction, and controls the video converter not to perform scaling in the horizontal direction and to perform scaling at a rate of 2.25-times (2.25×) and to perform filtering in the vertical direction.

4. The video signal processing apparatus of claim 1, comprising,
the display panel displaying a video outputted from the video converter in a screen having a resolution of at least twice a line number in the vertical direction of the game video and capable of drawing a video with arbitrary numbers of horizontal and vertical display pixels.

5. The video signal processing apparatus of claim 1,
wherein the predetermined video display mode is a mode to display a game video; and
wherein a screen setting menu dedicated to games to select the above mode is displayed.

6. The video signal processing apparatus of claim 1,
wherein the controller judges whether or not a type of an inputted video is of 480 P from format information of the video obtained via a control line of a terminal to which the analog video signal is inputted; and
wherein, in a case that the type of the video is of 480 P, an item to perform video conversion is displayed in the screen setting menu dedicated to games when the predetermined video display mode is “game mode”, and in a case that the type of the video is not of 480 P, an item to perform dot-by-dot display is displayed in the screen setting menu dedicated to games even when the predetermined video display mode is “game mode”.

7. A video signal processing method, comprising:
controlling, when input of a predetermined video display mode is received, a sampling frequency to make the number of display pixels in a horizontal direction of the video data be close to the number of pixels of a display panel;
generating digital video data by sampling an analog video signal with a predetermined resolution inputted from the outside at the controlled sampling frequency; and
controlling not to perform a scaling processing in a horizontal direction to the generated video data.
